(19) United States
(12) Patent Application Publication
(10) Pub. No.: US 2006/0071550 A1
(43) Pub. Date: Apr. 6, 2006

(54) Hydraulic actuator having an integrated pedal and pressure vessel assembly

(76) Inventor: James A. Buckley, Whitefish Bay, WI (US)

Correspondence Address: WHYTE HIRSCHBOECK DUDEK S C, 555 EAST WELLS STREET, SUITE 1900, MILWAUKEE, WI, 53202, US

(21) Appl. No.: 10/958,629

(22) Filed: Oct. 5, 2004

(51) Int. Cl. B60T 8/36

(52) U.S. Cl. 303/137

(57) ABSTRACT

A hydraulic actuator for a hydraulically actuated device such as a brake or a clutch comprises a pedal and a pressure vessel that is integral to the pedal and that has an outlet in fluid communication with an outlet of the pressure vessel, and an unpressurized reservoir. At least a portion of the pressure vessel and at least a portion of the pedal are formed integrally with one another from a single component. In addition, at least a portion of the reservoir is formed in a hollow interior portion of the brake pedal at a location that is spaced from the pressure vessel. The actuator may also include a mounting arrangement that receives the pressure vessel and pedal in a manner that permits the actuator to be preassembled as a completed unit before being mounted on the vehicle.

### BACKGROUND OF THE INVENTION

1. Field of the Invention

The invention relates to hydraulic actuators and, more particularly, relates to a hydraulic actuator that has an integrated pressure vessel and pedal assembly configured to supply pressurized hydraulic fluid to one or more hydraulically actuated devices, such as one or more brakes of a vehicle. The invention additionally relates to a vehicle equipped with such an actuator and to a method of fitting a vehicle with such an actuator.

2. Discussion of the Related Art

Pedal actuated hydraulic pressure vessels are used in many different systems. For example, master cylinder-based hydraulic brake systems are used on a wide variety of vehicles including trucks, automobiles, all terrain vehicles (ATVs), motorcycles, and bicycles. In all such systems, a brake such as a disk brake or drum brake is actuated by an actuator that includes a pressure vessel and a hand operated lever or foot operated pedal. (Hand levers and foot pedals are hereinafter collectively and individually referred to as “pedals” for the sake of convenience.) The pedal and pressure vessel are connected to one another such that pedal depression actuates the pressure vessel to pressurize the hydraulic fluid and deliver the pressurized hydraulic fluid to the associated brake or brakes. The pressure vessel and pedal are traditionally provided as separate components that are mounted on the vehicle independently of one another and that are connected to one another by a plunger and a mechanical linkage assembly. Brake actuators employing separate pressure vessels and pedals are well-suited for many applications but exhibit drawbacks rendering them less attractive for some applications.

For instance, the rear brake of most motorcycles is actuated by a foot pedal located in the vicinity of a footrest on the side of the motorcycle's frame. Depending upon the configuration of the frame and the location of the footrest, there may be insufficient room adjacent the brake pedal to accommodate a standard pressure vessel, requiring the use of a relatively expensive specially designed pressure vessel and/or a specially designed linkage connecting the brake pedal to a remote pressure vessel. In addition, the sprocket cover in which the typical motorcycle pressure vessel is mounted must be reinforced by a rib to support the pressure vessel. The pressure vessel is also very exposed, reducing the aesthetic appeal of the motorcycle and also exposing the pressure vessel and related components to damage.

The combined weight of the brake pedal and pressure vessel also significantly adds to the overall weight of the machine. While this is not problematic in some applications such as large motorcycles, it can be of great concern in other applications, such as racing motorcycles, where weight minimization is important.

In addition, regardless of its application, the costs of manufacturing and assembling a multi-component actuator with interconnected but separate brake pedal and pressure vessel considerably adds to the cost of a braking system.

Some of the problems cited above have been recognized and addressed by the prior art with varying degrees of success. For instance, U.S. Pat. No. 4,910,962 to Keane, U.S. Pat. No. 5,090,201 to Smith, U.S. Pat. No. 5,476,162 to Reed et al., and German Patent No. DE 39 32 529 to Schonlau all disclose systems in which a fluid pressure actuator includes a pedal and a pressure vessel or similar device that are integrated into a combined assembly as opposed to being mounted on the vehicle independently of one another. The Smith and Schonlau patents additionally propose forming the casing or housing for the system's pressure vessel or similar device directly from the pedal. All of these systems provide a more compact and, in some cases, more easily mountable, actuator than traditional actuators having separate and independently mounted pedals and pressure vessels. However, none of these systems solves or even addresses all of the problems described above.

For instance, the pressure vessels of the Keane patent and Reed patent still are formed separately from the pedals. They each are merely bolted or otherwise attached to the brake pedal to form a combined assembly that is mounted on the vehicle as a unit. As a result, although each system may be more compact than a comparable traditional system, component number reduction and weight reduction are limited, at best.

In addition, while both the Schonlau patent and Smith patent disclose an actuator in which a pressure vessel casing is integrated with a pedal, the overall design of both systems still fails to optimize compactness, weight reduction, or component part reduction. For instance, the actuator disclosed in the Schonlau patent requires an external reservoir or “backlash receiver” to supply unpressurized hydraulic fluid to the pressure vessel. The system therefore must be fitted with an additional fitting for connecting the actuator to the separate backlash reservoir, and the backlash reservoir and pressure vessel must be mounted on the vehicle at separate locations and connected to one another by an external line or hose. This situation might be acceptable for the automotive vehicular application disclosed in the Schonlau patent, but is less than optimal for motorcycle and related applications. In addition, only part of Schonlau's pressure vessel housing is integrated with the brake pedal. As a result, the pressure vessel piston is housed primarily by a cap that must be threaded into a tapped bore in the pressure vessel housing. This arrangement adds additional complexity and cost to the system. Pedal actuated hydraulic clutches and other pedal actuated systems having hydraulic pressure vessels experience similar drawbacks.

In light of the foregoing, a hydraulic actuator is required that has a more fully integrated pressure vessel and pedal assembly and that better achieves the advantages of compactness, weight reduction, component reduction, and/or assembly time reduction achieved by the prior art cited above.

The need has also arisen to provide a vehicle brake actuator that does not require the vehicle frame to be reinforced to support the system's pressure vessel and that does not obstruct access to the vehicle's footrest or other components in the vicinity of the brake pedal.

### OBJECTS AND SUMMARY OF THE INVENTION

In accordance with a first aspect of the invention, one or more of the above-identified needs is met by providing a hydraulic actuator that comprises a pedal and a pressure vessel that is integral to the pedal and that has an outlet in fluid communication with an outlet of the pressure vessel, an unpressurized reservoir, and a piston that is slidably disposed in the pressure vessel and that is responsive to pedal pivoting to selectively fluidically connect the pressurizable chamber and the reservoir to one another and isolate them from one another. In accordance with a preferred embodiment of the invention, at least a portion of the pressure vessel and at least a portion of the pedal are formed integrally with one part. In addition, at least a portion of the reservoir is formed in a hollow interior portion of the pedal at a location that is spaced from the pressure vessel. The actuator is well suited for use as a brake or clutch actuator.

The actuator may additionally include a mounting arrangement that is configured to mount the actuator on a mounting surface of the vehicle as a preassembled unit. The mounting arrangement may comprise a mounting bracket and a bolt configured for attaching the mounting bracket to the mounting surface. In this case, a return spring is preferably provided that acts on the pedal and the mounting bracket and that is configured to bias the pedal to a deactuated position thereof. The return spring imposes a preload force that holds the pedal and the mounting bracket together as a subassembly with the pedal biased into the deactuated position thereof. The return spring is preferably a torsion spring having a first end attached to the pedal and a second end attached to the mounting bracket.

The mounting arrangement may additionally comprise a reaction pin that is configured, when the actuator is mounted on the vehicle mounting surface, to extend through the mounting block and into the vehicle mounting surface along a line that is at least generally parallel to but offset from the pedal pivot axis. In this case, the pressure vessel further comprises a plunger that rests against the reaction pin and that translates upon pedal pivotal motion from a deactuated position thereof toward an actuated position thereof to drive the pressure vessel piston to move within the bore.

In order to render the actuator as self-contained and compact as possible, the reservoir could be formed entirely from the hollow interior portion of the pedal.

The benefits provided by the inventive actuator are particularly (but by no means exclusively) applicable to brakes or clutches for motorcycles or other vehicles. Hence, in accordance with other aspects of the invention, a vehicle system having an actuator configured at least generally as described above and a vehicle equipped with such as system are additionally provided.

In accordance with still other aspects of the invention, a method of making an actuator configured at least generally as described above and a method of using such an actuator are additionally provided.

Other objects, features, and advantages of the invention will become apparent to those skilled in the art from the following detailed description and accompanying drawings. It should be understand, however, that the detailed description and specific examples, while indicating the preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout, and in which:

FIG. 1 is a somewhat schematic side elevation view of a motorcycle having a brake actuator constructed in accordance with a first preferred embodiment of the invention;

FIG. 2 is a detail side elevation view of a portion of FIG. 1, showing the brake actuator and a corresponding portion of the motorcycle;

FIG. 3 is a perspective view of the structures illustrated in FIG. 2 and showing the brake actuator partially disassembled and removed from the motorcycle frame;

FIG. 4 is an exploded perspective view of the structures illustrated in FIG. 3;

FIG. 5 is a side elevation view of the structures illustrated in FIG. 2, showing the brake actuator in cutaway form in its at rest or deactuated position;

FIG. 6 is a side elevation view corresponding to FIG. 5 and showing the brake actuator in its actuated position;

FIG. 7 corresponds to FIG. 5 but illustrates a second embodiment of the brake actuator; and

FIG. 8 corresponds to FIG. 6 but illustrates the second embodiment of the brake actuator.

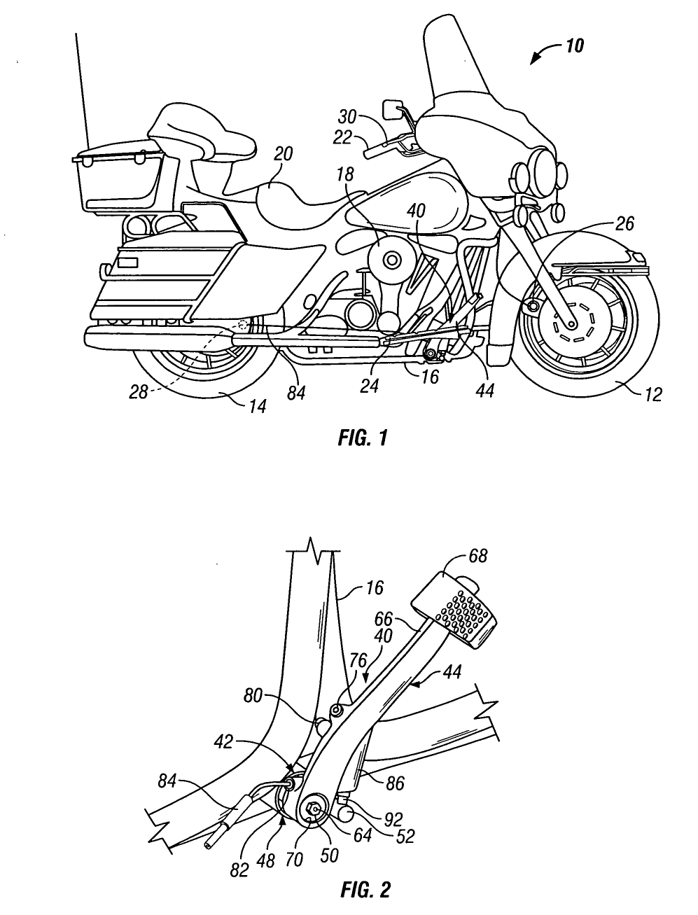

### DETAILED DESCRIPTION OF THE PREFERRED EMBODIMENTS

A wide variety of different hydraulic actuators for a variety of different applications could be constructed in accordance with the invention as defined by the claims. Hence, while preferred embodiments of the invention will now be described with reference to a foot pedal actuated motorcycle rear brake actuator, it should be understood the invention is in no way so limited. For example, it is also usable with a variety of foot operated or hand operated clutch and brake systems for a variety of different vehicles such as ATVs and snowmobiles.

Referring now to the drawings, a brake actuator 40 constructed in accordance with one embodiment of the invention is shown as being installed on a conventional motorcycle 10. The motorcycle 10 includes front and rear wheels 12, 14 and a frame 16 that is supported on the front and rear wheels 12, 14 in a conventional manner. The frame 16 supports the remaining components of the motorcycle including an engine 18, a seat 20, handlebars 22, footrests 24, etc. The front and rear wheels 12 and 14 are each equipped with associated hydraulic disk brakes 26 and 28, respectively. The front brake 26 is actuated by a conventional squeeze grip type lever 30 located adjacent one of the handlebars 22. The rear brake 28 is actuated by the actuator 40.

The rear brake actuator 40 comprises a preassembled unit mounted on a mounting location of the motorcycle 10 at a convenient location for access by the operator's foot. In the illustrated embodiment, that location is on the right side of the motorcycle's frame 16 inboard of the right footrest 24. Significantly, the actuator 40 is sufficiently compact so as not to interfere with standard footrest placement. The actuator 40 can also be mounted directly to the frame 16 without having to provide reinforcing ribs on a sprocket cover to accommodate a separate pressure vessel. Referring to FIGS. 2-4, the actuator 40 includes a mounting arrangement 42, a brake pedal 44, and a piston end 46. All three components will now be described in turn.

The mounting arrangement 42 preferably is configured to support the brake pedal 44, the piston end 46, and a reaction device for the pressure vessel piston while holding the brake pedal 44 together as a preassembled, preferably preloaded, unit. The mounting arrangement 42 of the illustrated embodiment includes a mounting block 48, a main mounting bolt 50, and a reaction pin 52. The mounting block 48 comprises a metal (preferably aluminum) casting having an outer surface 54 and an inner surface 56 that is configured to rest against the vehicle mounting surface. The vehicle mounting surface comprises the motorcycle frame 16 in this embodiment. First and second cylindrical bores 58 and 60 extend through the mounting block 48 from the outer surface 54 to the inner surface 56. The first or main cylindrical bore 58 is configured to receive the brake pedal 44 and the mounting bolt 50. The second, smaller bore 60 is offset from the first bore 58 and is configured to receive the reaction pin 52. As explained in more detail below, the bolt 50 is coincident with the pivot axis of the brake pedal 44. The reaction pin 52 is positioned relative to this pivot axis so that, as the brake pedal 44 pivots about the bolt 50, the piston end 46 rotates about the reaction pin 52 to actuate the pressure vessel piston 92 as detailed below.

Referring now to FIGS. 2-6, the brake pedal 44 comprises a hollow component, preferably formed from lightweight aluminum. It includes, from inner to outer ends, a shank 62 extending coaxially with a pivot axis 64 of the brake pedal 44, a lever portion 66 extending away from the shank 62 generally radially from the pivot axis 64, and a foot pad 68 located on the outer end of the lever portion 66. A bore 70 is formed through the shank 62 coincident with the pivot axis 64 for receiving the mounting bolt 50. The bore 70 also is counterbored at its outer axial end to accommodate the head of the mounting bolt 50. At least part of the lever portion 66 is hollow to both 1) reduce the weight of the brake pedal 44 and 2) provide an interior chamber 72 serving as a reservoir for the pressure vessel 46. Essentially the entire lever portion 66 preferably is hollow in order to maximize available space for the reservoir 72 and to minimize the weight of the brake pedal 44. A hollow pedal also is quite rigid in terms of torsion and bending. In the illustrated embodiment, the hollow interior of the lever portion 66 provides about 4 in³ of reservoir volume, which is more than adequate for most motorcycle brake applications.

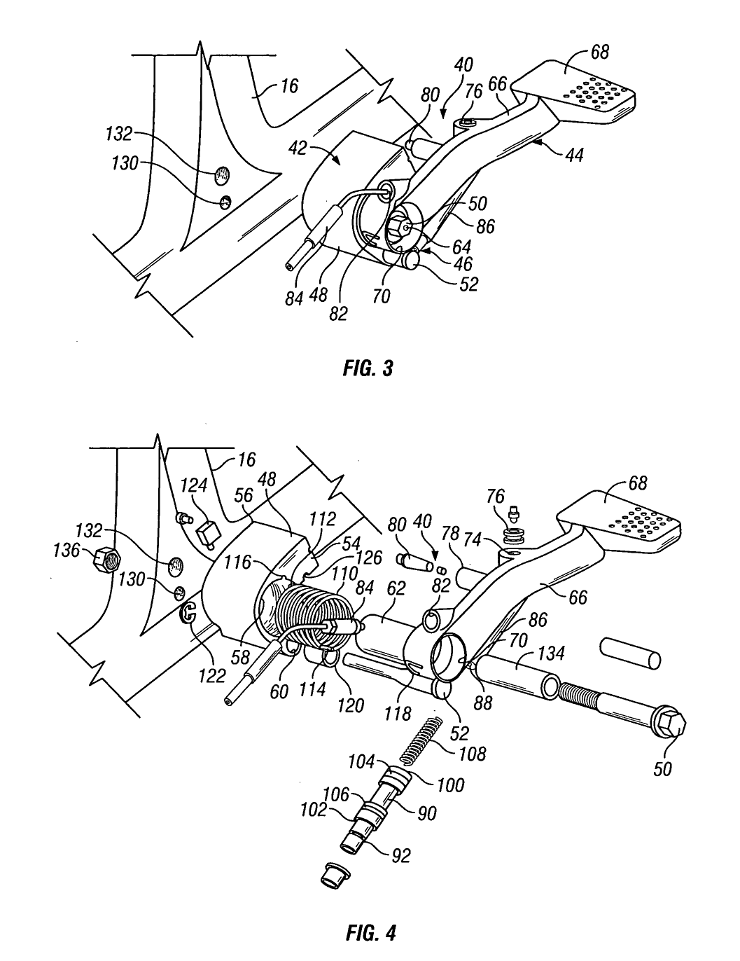

Referring to FIGS. 3-6, the reservoir 72 is filled via a fill port (74) located near the front end of the lever portion 66. The fill port 74 preferably is closable by a site glass 76 that permits visual inspection of the fluid level in the reservoir 72. Air can be bled out of the reservoir 72 via a bleed port 78 that is cast into the inboard side of the lever portion 66 and that is closed by a conventional bleed screw 80 as best seen in FIG. 4. Another port 82, located on the inner end portion of the lever portion 66, serves as an inlet/outlet port for connecting a high pressure chamber (detailed below) of the pressure vessel to the brake 28 via a brake line 84.

The brake pedal 44 includes a pressure vessel 86 that has an inner bore 88, a piston 90 that slides disposed in the bore 88, and a plunger portion of piston 92 that interacts with the reaction pin 52 upon brake pedal pivoting motion to drive the piston 90 to move relative to the pressure vessel 86 to apply the brake 28. At least part, and preferably the entire, pressure vessel 86 is cast integrally with the remainder of the brake pedal 44 as seen in FIGS. 4-6. It preferably is cast on or into the lower portion of the brake pedal lever portion 66 to render it as inconspicuous as possible and minimize the overall width of the actuator 40. In the illustrated embodiment, the lower perimeter of the pressure vessel 86 is formed from a protrusion on the bottom surface of the lever portion 66 of the brake pedal 44. A high pressure port 94 is formed near the front end of the bore 88 and is connected to the inlet/outlet port 82 via an internal passage (not shown). Conventional timing and compensation ports are also formed in the sidewall of the pressure vessel 86 between the vessel's front and rear ends. These ports preferably are combined into a single elongated port 96 in order to facilitate the casting of those ports directly into the pressure vessel 86 as opposed to drilling into the pressure vessel in a post casting machining process. Multiple combined ports may be provided, if desired, to increase the flow area. Two circumferentially spaced ports 96 are provided in the illustrated embodiment. The volume in front of the ports 96 defines a pressurizable chamber 98 that is pressurized upon pedal actuation to apply the brake 28 as detailed below.

The integrated brake pedal 44 and pressure vessel 86 assembly preferably is cast in a lost core casting process. A particularly preferred process involves the casting of a thixotropic aluminum alloy around a zinc core and subsequently melting the zinc core from the alloy. This process permits the formation of interior structures of the brake pedal and pressure vessel, such as the ports, 74, 78, 82, etc., directly during the casting process without requiring the use of mechanical pins and without post casting drilling, milling, or other functions. Such a thixotropic alloy melt away melting process is described in greater detail in U.S. Pat. Nos. 6,564,856 and 6,427,755, the subject of both of which are hereby incorporated by reference.

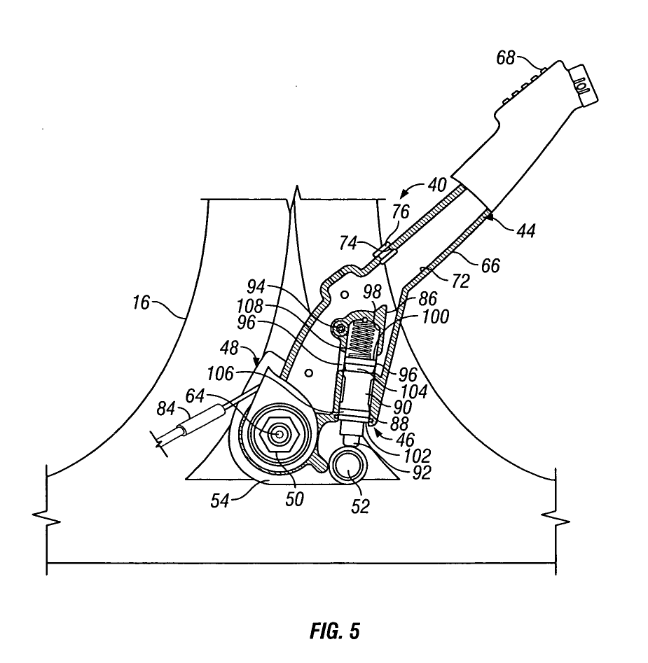

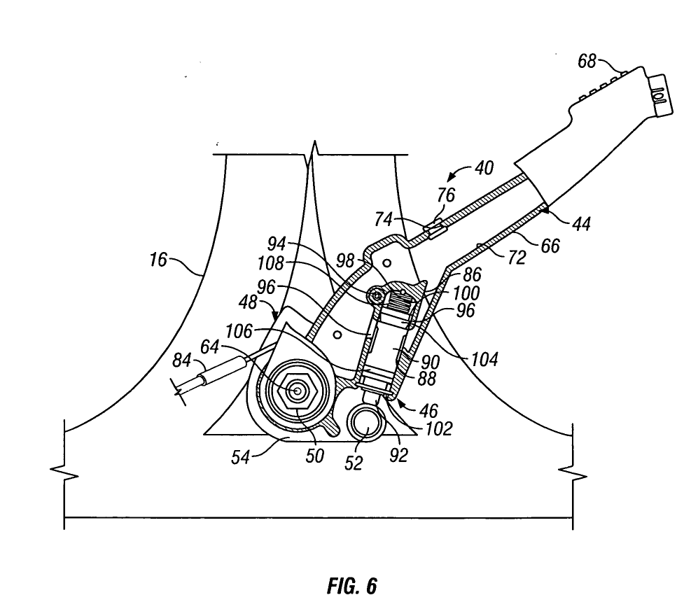

Referring to FIGS. 4-6, the piston 90 has an imperforate front end 100, a socket (not shown) formed in the rear end 102 thereof, and bears front and rear seals 104 and 106 near the associated front and rear ends 100 and 102. The rear seal 106 seals the combined ports 96 from the rear end of the bore 88. The front seal 104 selectively connects the high pressure port 94 to the combined ports 96 and isolates those ports from one another. Specifically, when the brake pedal 44 is in its at rest or deactuated position of FIG. 5 and the pressure vessel piston 90 is in a corresponding deactuated position, a sealing lip on the front seal 104 is positioned behind the front edge of each of the combined ports 96 in the pressure vessel 86 to connect the reservoir 72 to the pressurizable chamber 98, hence depressurizing the chamber 98 and the brake line 84. Conversely, when the brake pedal 44 assumes its actuated position as seen in FIG. 6, the front seal 104 isolates the reservoir 72 from the chamber 98 and permits the chamber 98 to be pressurized upon additional forward piston travel to supply pressurized fluid to the rear brake 28 through the line 84.

Referring to FIGS. 3-6, the plunger 92 extends rearwardly from the piston 90 to the reaction pin 52. It's front end is connected to the piston 90 via a ball and socket connection or some other connection that permits limited pivoting motion of the plunger 92 relative to the piston 90 in order to accommodate changes in inclination as the brake pedal 44 rotates about the reaction pin 52. The rear end of the plunger 92 cooperates with the reaction pin 52, either in an abutting manner as seen in FIGS. 5 and 6 or via a yoke or some similar connection.

Referring to FIGS. 4-6, the piston 90 is biased towards its deactuated position by a spring 108 which, in this embodiment, comprises a compression spring 108 provided between the front end 100 of the piston 90 and the front end of the chamber 98. The brake pedal 44 is likewise biased towards its deactuated position by a return spring 110 which, in the preferred embodiment, comprises a torsion spring connected to the brake pedal 44 and the mounting block 48 as detailed below.

To assemble the actuator 44, the torsion spring 110 is mounted over the shank 62 on the brake pedal 44, the shank 62 is then inserted into the bore 58 of the mounting block 48. First and second tangs 112 and 114 on the ends of the torsion spring 110 are then attached to corresponding receptacles 116 and 118 formed on the mounting block 48 and the brake pedal 44, respectively. The torsion spring 110 is pre-stressed to provide a preload on the brake pedal 44. This preload holds the brake pedal 44 in its deactuated position and also holds the brake pedal 44 and mounting block 48 together as a unit. The spring 108 and piston 90 are then inserted into the bore 88 and held in a forward position within the bore 88 while the reaction pin 52 is inserted through a bushing 120 and then through the bore 60 in the mounting block 48 and clipped in place against the mounting block using a clip 122. The plunger 92 can then be released, whereupon it is held against the bushing 120 by the return spring 108. Finally, a conventional brake light switch 124 is mounted in a slot 126 on the mounting block 48 in a position in which it is responsive to brake pedal pivotal movement to actuate a brake light (not shown).

The actuator 40 is now fully preassembled and ready for mounting on the motorcycle 10 as a unit. All of these operations can be performed at the factory so that the motorcycle manufacturer or other end user can receive the actuator 40 as a preassembled unit ready for mounting on the motorcycle 10.

Referring to FIGS. 3 and 4, the preassembled actuator 40 can then be mounted on the motorcycle 10 simply by positioning the mounting block 48 at a location in which the rear surface 56 of the mounting block 48 rests against the motorcycle frame 16, the reaction pin 52 extends through a first bore 130 in the frame 16, and the main bore 58 in the mounting block 48 is aligned with a second bore 132 in the motorcycle frame 16. The mounting bolt 50 is then inserted through a bushing 134, through the bore 70 in the shank 62, through the bore 132 in the frame 16, and affixed to the frame via a nut 136 on the back side of the frame 16. The bolt 50 now serves as both the primary support surface for the actuator 40 and as a pivot axis for the brake pedal 44. The reaction pin 52 prevents the mounting block 48 from rotating about the bolt 50 and also provides additional support for the actuator 40. The steel reaction pin 52 also accommodates bending and sheer forces that are imposed on the brake pedal 44 in an overload type situation, hence reducing the load on the parts and permitting the use of lighter weight, less robust parts than would otherwise be required. Finally, to ready the actuator 40 for operation, the brake line 84 is connected to a fitting to port 82, and the reservoir 72 is filled via the fill port (14) and bled via the bleed port 78.

The assembled actuator 40 has approximately 50% fewer parts than a comparable traditional multi-component motorcycle rear brake actuator. It also weighs approximately 50% less than the comparable traditional motorcycle rear brake actuator.

To operate the rear brake 28 of the motorcycle 10, the operator simply places his or her foot on the foot pad 68 of the brake pedal 44 and depresses the brake pedal to pivot it from the position illustrated in FIG. 5 toward the position illustrated in FIG. 6. This pivoting motion causes the pressure vessel 46 to rotate toward the reaction pin 52, hence decreasing the distance between the reaction pin 52 and the rear end of the pressure vessel bore 88 and causing the plunger 92 to drive the pressure vessel piston 90 from the position illustrated in FIG. 5 to the position illustrated in FIG. 6. This pivoting motion is resisted by the torsion spring 110, which provides about 2-3 lbs. of resistance at the foot pad 68. This resistance is equivalent to the resistance provided by a 25 lb. return spring of a conventional pressure vessel. The timing port portion of each of the combined ports 96 begins to close immediately upon this brake pedal travel and brake light is activated. Additional pedal stroke closes the front end of the ports 96, thereby completely isolating the reservoir 72 from the chamber 98. Additional pedal depression causes the piston 90 to move forwardly into the chamber 98 to generate hydraulic pressure in the chamber 98 and force pressurized hydraulic fluid to the brake 28 through the ports 94 and 82 and the brake line 84. Referring to FIGS. 5 and 6, the piston 90 moves generally linearly with brake pedal 44 stroke through the full range of brake pedal 44 travel due to the fact that the angle a between a longitudinal bisector of the brake pedal 44 and the longitudinal axis of the piston 90 is relatively small, preferably on the order of 20°-40°, and more preferably about 30°. Additional brake pedal travel generates fluid pressure to apply the brake 28.

When the operator removes his or her foot from the pad 68, the brake pedal 44 returns immediately to its deactuated position under the return force of the torsion spring 110 and hydraulic pressure. The piston 90 simultaneously returns to its deactuated position under the return force of the return spring 108, hence increasing the volume of the chamber 98 and permitting fluid to flow back into the chamber 98 from the brake 28 and, ultimately, re-opening the combined timing and spill ports 96 to reconnect the chamber 98 to the reservoir 72.

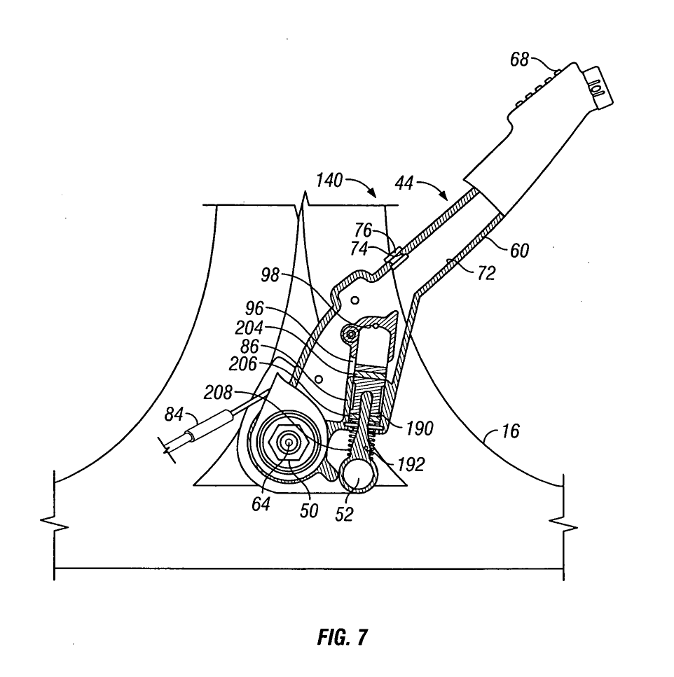

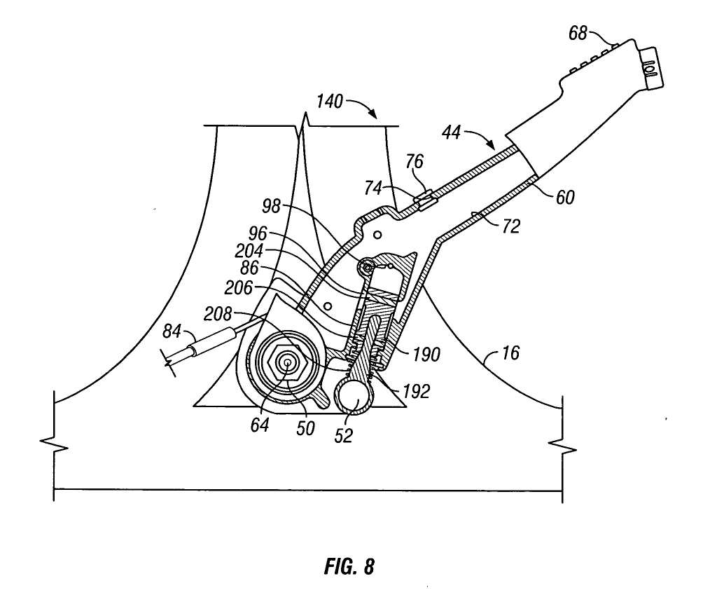

Referring now to FIGS. 7 and 8, a brake actuator 140 constructed in accordance with a second embodiment of the invention is illustrated that differs from the actuator 40 of the first embodiment only in that it employs a slightly different piston, plunger, and return spring assembly. It is otherwise identical to the actuator 40 of the first embodiment, including the same mounting block 48, the same integrated brake pedal/pressure vessel 44, 86, the same torsion spring 110, the same mounting bolt 50, the same reaction pin 52, etc. All of the common components of both actuators 40 and 140 are therefore designated by the same reference numerals. The remaining components of the actuator 140 are functionally comparable to corresponding components of the actuator 40 of the first embodiment and, accordingly, are designated by the same reference numerals incremented by 100.

Referring to FIG. 7, the compression spring 108 of the first embodiment is replaced by a tension spring 208 mounted over the plunger 192. The tension spring 208 is affixed to the plunger 192 and to the rear of the piston 190 so as to normally hold the piston in the position illustrated in FIG. 7. This tension spring 208 effectively holds the piston 190 to the plunger 192 during braking but permits the plunger 192, piston 190, and spring 208 to be preassembled as a subassembly prior to insertion into the pressure vessel 86, hence facilitating assembly when compared to the first embodiment. In addition, rather than being formed with a bulbous end that simply rests on a bushing or similar element, the rearmost end of the plunger 192 is attached to or formed from a yoke that surrounds the reaction pin 52. The actuator 140 of the embodiment otherwise functions identically to the actuator 40 of the first embodiment and, accordingly, will not be described in further detail.

As indicated above, many changes and modifications may be made to the present invention without departing from the spirit thereof. The scope of some of these changes are discussed above. The scope of others will become apparent from the appended claims.

I claim:

1. A hydraulic actuator, comprising:
(A) a pedal; and
(B) a pressure vessel that is located in said pedal and that has a pressurizable chamber, outlet, an unpressurized reservoir, and a piston that is slidably disposed in said pressure vessel and that is responsive to pedal pivoting to selectively fluidically connect said pressurizable chamber and said reservoir to one another and isolate them from one another,
wherein at least a portion of said pressure vessel and at least a portion of said pedal are formed integrally with one another from a single component and wherein
at least a portion of said reservoir is formed in a hollow interior portion of said pedal at a location that is spaced from said pressure vessel.

2. The actuator as recited in claim 1, further comprising a plunger which is configured to drive said pressure vessel piston upon pedal movement.

3. The actuator as recited in claim 2, wherein said plunger has an axial centerline that is offset from a longitudinal bisector of said pedal by no more than about 40°.

4. The actuator as recited in claim 1, further comprising a mounting arrangement that is configured to mount said actuator on a mounting surface of the vehicle as a preassembled unit.

5. The actuator as recited in claim 4, wherein said mounting arrangement comprises a mounting bracket and a bolt configured for attaching the mounting bracket to the mounting surface, and further comprising a return spring that acts on said pedal and said mounting bracket and that is configured to bias said pedal to a deactuated position thereof, said return spring imposing a preload force that holds said pedal and said mounting bracket together as a subassembly with said pedal biased into said deactuated position thereof.

6. The actuator as recited in claim 5, wherein said return spring is a torsion spring having a first end attached to said pedal and a second end attached to said mounting bracket.

7. The actuator as recited in claim 4, wherein said pedal includes a tubular shank extending coaxially with a pivot axis of said pedal, and wherein the mounting arrangement comprises
a mounting block that has an outer surface and an inner surface configured to rest against the vehicle mounting surface, and a cylindrical bore extending from said outer surface to said inner surface and receiving said pedal shank; and
a bolt that is configured, when said actuator is mounted on the vehicle mounting surface, to extend through said pedal shank and said mounting block coaxially with said pedal pivot axis so as to mount said actuator to the vehicle mounting surface.

8. The actuator as recited in claim 7, wherein said mounting arrangement further comprises a reaction pin that is configured, when said actuator is mounted on the vehicle mounting surface, to extend through said mounting block and into the vehicle mounting surface along a line that is at least generally parallel to but offset from said pedal pivot axis, and wherein said pressure vessel further comprises a plunger that rests against said reaction pin and that translates upon pedal pivotal motion from a deactuated position thereof toward an actuated position thereof to drive said pressure vessel piston to move within a bore.

9. The actuator as recited in claim 8, further comprising a return spring that urges said pressure vessel piston to a deactuated position of said pressure vessel.

10. The actuator as recited in claim 9, wherein said return spring is a compression spring that is located in said pressurizable chamber and that is configured to push said pressure vessel piston toward said deactuated position thereof.

11. The actuator as recited in claim 9, wherein said return spring is a tension spring configured to pull said piston toward said deactuated position thereof.

12. The actuator as recited in claim 1, wherein said reservoir is formed entirely from said hollow interior portion of said pedal.

13. The actuator as recited in claim 1, wherein said actuator is configured for use as a brake actuator and said pedal is a brake pedal.

14. The actuator as recited in claim 13, wherein said actuator is configured for use as a motorcycle rear brake actuator and is configured for mounting on a motorcycle frame in the vicinity of a footrest.

15. A brake actuator comprising:
(A) a brake pedal at least a portion of which is formed from cast metal and which has an interior chamber;
(B) a pressure vessel including a pressure vessel that is portion of said brake pedal, a pressurizable chamber that is located in said pedal and that has an outlet in fluid communication with an outlet of said pressure vessel, an unpressurized reservoir formed at least in part from said interior chamber of said brake pedal, and a piston that is slidably disposed in said pressure vessel and that is responsive to brake pedal pivoting to selectively fluidically connect said pressurizable chamber and said reservoir to one another and isolate them from one another; and
(C) a mounting arrangement that is configured to mount said actuator on a mounting surface of a vehicle as a preassembled unit.

16. The brake actuator as recited in claim 15, wherein said brake actuator is configured for use on a motorcycle.

17. The actuator as recited in claim 15, wherein said mounting arrangement comprises a mounting block and a bolt configured for attaching the mounting block to the mounting surface of the vehicle, and further comprising a return spring that is attached to said brake pedal and to said mounting block and that is configured to bias said brake pedal to a deactuated position thereof, said return spring imposing a preload force that holds said brake pedal and said mounting block together as a subassembly with said brake pedal biased into said deactuated position thereof.

18. A vehicle comprising:
(A) a frame;
(B) wheels on which the frame is supported;
(C) a hydraulically actuated brake configured to brake at least one of the wheels;
(D) a brake actuator that is mounted on said frame and that includes
(1) a brake pedal that is pivotable with respect to said frame, and
(2) a pressure vessel integral to said brake pedal that has an outlet in fluid communication with said brake, a pressurizable chamber in flud communication with said pressure vessel outlet, an unpressurized reservoir, and a piston that is slidably disposed in said pressure vessel and that is responsive to brake pedal pivoting to selectively fluidically connect said pressurizable chamber and said reservoir to one another and isolate them from one another.

19. The vehicle as recited in claim 18, wherein said brake pedal includes an interior chamber serving as said reservoir.

20. The vehicle as recited in claim 18, further comprising a footrest mounted on a side of said frame, and wherein said actuator is mounted on said frame adjacent said footrest.

21. A method of assembling a hydraulically actuated system, comprising:
(A) providing a hydraulic actuator including a pressure vessel and a pedal in the form of a preassembled unit, at least a portion of said pressure vessel and at least a portion of said pedal being formed from a single component; and then
(B) mounting said preassembled unit on a mounting surface of said vehicle.

22. The method as recited in claim 21, wherein the mounting step comprises bolting a mounting bracket of said actuator to the mounting surface of said vehicle using a bolt extending axially with a pivot axis of said brake pedal.

23. The method as recited in claim 22, wherein the mounting step further comprises inserting a reaction pin into said vehicle mounting surface, said reaction pin extending along a line that is at least generally parallel to but offset from the pedal pivot axis and serving as reaction surface for a plunger that drives a piston of said pressure vessel to translate within a bore of said pressure vessel.

24. The method as recited in claim 22, wherein the providing step comprises providing a return spring that is attached to said pedal and to said mounting bracket and that is configured to bias said pedal to a deactuated position thereof, said return spring imposing a preload force that holds said brake pedal and said mounting bracket together as a subassembly with said brake pedal biased into the deactuated position thereof.

25. A method of braking a vehicle comprising:
driving a brake pedal to pivot about a pivot axis thereof from a deactuated position to an actuated position in order to drive a pressure vessel piston to move relative to a pressure vessel to
(1) first isolate an unpressurized reservoir of said pressure vessel from a pressurizable chamber of said pressure vessel, and then
(2) generate hydraulic pressure in said pressurizable chamber of said pressure vessel to apply a hydraulic brake, wherein
at least a portion of said pressure vessel and at least a portion of said brake pedal are formed integrally with one another and
at least a portion of said reservoir is formed from an interior chamber of said brake pedal at a location that is spaced from said pressure vessel.

26. The method as recited in claim 25, wherein said pressure vessel piston and said pressure vessel move generally linearly relative to one another throughout a full range of brake pedal travel.

27. The method as recited in claim 26, wherein, during the isolating portion of the driving step, a seal on said pressure vessel piston sequentially closes a timing port portion and a compensating port portion of an elongated bore in said pressure vessel.

28. The method as recited in claim 27, wherein the driving step is resisted by a spring that also holds said brake pedal and a mounting bracket for said brake pedal together as a preassembled unit.
